(19) United States
(12) Patent Application Publication
(10) Pub. No.: US 2017/0206866 A1
(43) Pub. Date: Jul. 20, 2017

(54) GUITAR BRIDGE WITH TONAL ENHANCEMENT

(71) Applicant: DRUM WORKSHOP, INC., Oxnard, CA (US)

(72) Inventor: WILLIAM A. XAVIER, Oxnard, CA (US)

(21) Appl. No.: 15/408,332

(22) Filed: Jan. 17, 2017

Related U.S. Application Data
(60) Provisional application No. 62/280,020, filed on Jan. 18, 2016.

(51) Int. Cl. G10D 3/04; G10D 3/02

(52) U.S. Cl. CPC G10D 3/04; G10D 3/02

(57) ABSTRACT

The present disclosure describes a stringed instrument employing a bridge coupled to the soundboard of the instrument via a plate. By selecting the material composition of the bridge and controlling the coupling between the bridge and the soundboard, an aspect of the present disclosure provides for different tonal enhancements and/or tonal transmissions between the bridge and the soundboard. The bridge can be part of an assembly also including a plate and one or more connectors configured to connect the bridge and plate through a soundboard. The bridge can define various different recesses which may be connected to one another for ease of use, and may have a flat bottom surface for contacting a soundboard. The bottom surface may also be non-flat, textured, and/or include recesses.

The present application claims priority to U.S. Provisional Pat. App. No. 62/280,020 to Xavier, filed on Jan. 18, 2016 and entitled “Guitar Bridge with Tonal Enhancement,” which is fully incorporated by reference herein in its entirety.

### BACKGROUND OF THE DISCLOSURE

Field of the Disclosure

Aspects of the present disclosure generally relate to stringed instruments, and more specifically, the present disclosure relates to guitar bridges having tonal enhancement characteristics.

Description of the Related Art

Musical notes have been created using many forms of instruments and devices. Stringed instruments, where gut, nylon, steel, and/or other materials are placed under tension and plucked or strummed, have been in existence for approximately 3000 years.

Modern stringed instruments take many forms. A popular stringed instrument is the guitar, which also has many different types. Although guitars have many different applications in musical composition and performance, the principle of operation is very similar across the spectrum of guitars that are available. A number of strings are placed under tension between two end points, and the strings are vibrated, either alone or in conjunction with other strings. Depending on the tension and the length of each string, the vibrations produce different frequencies, or “notes” within a song or composition.

Materials used for the strings, guitar, plectrum (or “pick”) and/or other parts of the guitar also affect the tonal qualities of the frequencies generated by such instruments. For example, a guitar string made of steel will have a different tone than a string made from nylon, even if the two strings are vibrating at the same frequency. Further, the design of an instrument, in terms of the shape, construction, and/or other design characteristics will also affect the tonal qualities produced by the instrument. For example, a guitar made from a certain type of wood, e.g., spruce, will sound different than a guitar made from a harder wood such as birch, and both will sound different than a guitar made of metal.

Depending on the type of music being played, different tonal qualities of a guitar, or any instrument, may be more desirable. For example, a flamenco style piece may emphasize different tonalities and tonal relationships between notes than a jazz style of music. Some musical pieces employ different consonance (relaxation and/or harmonization) and dissonance (tension and/or conflict) between the tonic (the central note of a chord or piece of music) and the other notes in a musical composition.

However, guitar manufacturers do not necessarily know what type of music a given guitar player will be playing, and, as such, cannot economically produce a guitar that has a specific tonal quality (e.g., more reverberation at higher frequencies) at the expense of other characteristics (e.g., less reverberation at lower frequencies). Guitars are often manufactured to produce a balance of consonance and dissonance across a wide range, and any emphasis on specific tonal characteristics may merely be a remnant of trade-offs made during instrument design.

### SUMMARY OF THE DISCLOSURE

The present disclosure describes a stringed instrument employing a bridge coupled to the soundboard of the instrument via a plate. By selecting the material composition of the bridge and controlling the coupling between the bridge and the soundboard, an aspect of the present disclosure provides for different tonal enhancements and/or tonal transmissions between the bridge and the soundboard.

One embodiment of a guitar bridge assembly in accordance with an aspect of the present disclosure comprises a bridge and a plate, coupled to the bridge, in which a soundboard of a guitar is coupled between the plate and the bridge, in which a material is selected for the bridge to alter the tonal qualities of the guitar.

One embodiment of a stringed instrument in accordance with an aspect of the present disclosure comprises a soundboard, a bridge on a portion of a first side of the soundboard, and a plate on a portion of a second side of the sound board at least partially overlapping with the portion of the first side such that the soundboard is sandwiched between the bridge and the plate.

One embodiment of a guitar bridge in accordance with an aspect of the present disclosure comprises a top surface and a bottom surface, with the top surface shaped to define a recess and a plurality of string guides adjacent said recess.

One embodiment of a guitar bridge assembly in accordance with an aspect of the present disclosure comprises a bridge, a plate shaped to define one or more coupling holes, and one or more connectors configured to connect the plate to the bridge through the soundboard, with at least one connector passing through a coupling hole and attaching to the bridge.

The above summary has outlined, rather broadly, some features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same or similar purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates one embodiment of a guitar in accordance with an aspect of the present disclosure.

FIG. 2 illustrates an internal view of one embodiment of a soundboard in an aspect of the present disclosure.

FIGS. 3 and 4 illustrate perspective cutaway views of one embodiment of a guitar bridge assembly in accordance with an aspect of the present disclosure.

FIG. 5 illustrates a top view of one embodiment of a guitar bridge in accordance with an aspect of the present disclosure.

FIGS. 6 and 7 illustrate cross-sectional views of the guitar bridge shown in FIG. 5.

FIG. 8 illustrates a top view and cross-sectional view of one embodiment of a guitar bridge in accordance with an aspect of the present disclosure.

FIG. 9 illustrates a top view of one embodiment of a plate in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those reasonably skilled in the art that these concepts may be practiced without these specific details. In some instances, structures and components are shown in block diagram form in order to aid in avoiding obscuring such concepts. As described herein, the use of the term “and/or” is intended to represent an “inclusive OR”, and the use of the term “or” is intended to represent an “exclusive OR”.

### Overview

Music, and musical compositions such as songs, are often written and/or composed to evoke emotions and/or feelings in the listener. Musical presentations combine tones and harmonics (also known as “overtones”) to tell a story. Many different types of musical instruments, e.g., stringed instruments, percussive instruments, wind instruments, etc., may be used, alone or in combination, to present the artist's interpretation of a feeling and/or emotion through auditory stimuli.

An aspect of the present disclosure describes a guitar (or other stringed instrument) bridge assembly. The bridge shape, thickness, and/or material may accentuate certain tonal qualities of the string vibrations, and when coupled to a guitar soundboard, may produce additional sustain for tonic (central tone) notes. In an aspect of the present disclosure, the bridge may be modified or tuned, either during manufacture or by the user, to accentuate and/or de-accentuate specific tonal qualities of the instrument.

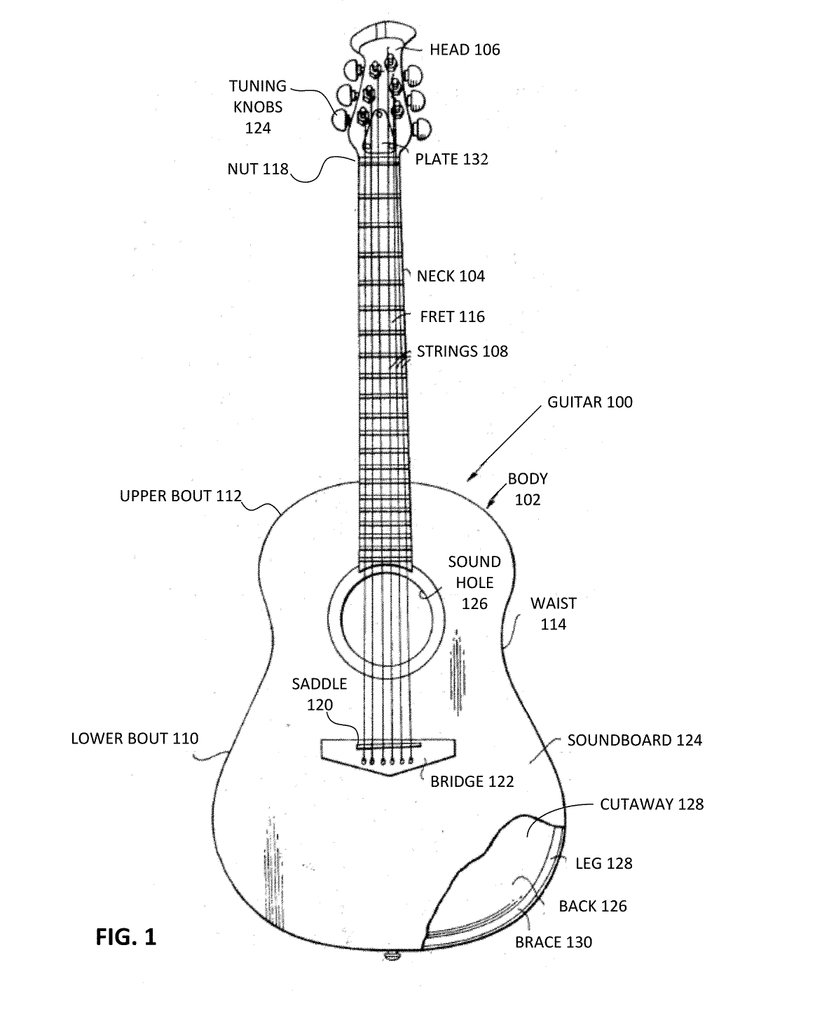

FIG. 1 illustrates one embodiment of a guitar in accordance with an aspect of the present disclosure.

Guitar 100, which may be an acoustic guitar, acoustic-electric guitar, or electric guitar, for example, comprises a body 102, a neck 104, and a headstock (also referred to as a “head” or “peg head”) 106. For acoustic and/or acoustic-electric guitars, body 102 may be hollow, or semi-hollow, in that body 102 may create an acoustic chamber to amplify the noise caused by the vibrations of strings 108.

Although shown in FIG. 1 as a six-string guitar 100, guitar 100 may also be a bass guitar having any number of strings, a twelve-string guitar, a double-neck guitar, a mandolin, a ukulele, a lute, a kora, an oud, a sitar, a mountain dulcimer, and/or any other stringed instrument or instrument that operates on similar principles without departing from the scope of the present disclosure. Any reference herein to “guitar 100” comprises any stringed instrument that operates on principles similar to those described in the present disclosure.

As shown in FIG. 1, body 102 may be shaped to include a lower bout 110 and an upper bout 112. The lower bout 110 accentuates the lower frequencies (also referred to as “notes” or “tones” herein) while the upper bout 112 accentuates the higher frequencies that are produced by strings 108. Lower bout 110 and upper bout 112 are coupled at waist 114.

Neck 104 may comprise one or more frets 116. Strings 108, which may have varying diameters and masses, are strung under tension between saddle 120 and nut 118. The varying frequencies strings 108 may produce is controlled at least in part by the distance between saddle 120 and nut 118, the weight (mass) of each string 108, the material of each string 118, and the tuning knobs 124, to name a few. The frequency produced by each string 108 can also be changed by clamping the string 108 at frets 116 on neck 104, which changes the operative length of string 108. As the vibrational length of string 108 is shortened, higher frequencies are produced when string 108 is plucked or otherwise moved. Frets 116 are sized and spaced between nut 118 and saddle 120 on bridge 122 to produce different notes.

Body 102 also comprises a soundboard 124, which is the “top” and/or top surface of guitar 100. As strings 108 are vibrated, saddle 120 also vibrates, and transfers the vibrations generated by moving strings 108 through bridge 122 onto soundboard 124. Soundboard 124, having a larger area, transfers these vibrations into body 102, which produces air movement between soundboard 124 and back 126 of body 102 (shown in cutaway 128). Back 126 may be attached to soundboard 124 by leg 128 and/or brace 130, which may be substantially coupled along an outer portion of back 126 and/or an outer portion of soundboard 124.

As previously described, the vibrational frequency of string 108 is transferred to body 102 via saddle 120, which in turn transfers the vibrations to bridge 122. The bridge 122 transfers vibrations to soundboard 124, and thus into the hollow body 102 of guitar 100. These vibrations are then amplified by the hollow space of body 102 between soundboard 124 and back 126, and cause sound to be emitted from guitar 100 via one or more sound holes 126.

In some acoustic-electric guitars 100, saddle 120 may comprise one or more transducers that transform the vibration of strings 108 into an electrical signal, which signal may travel from guitar 100 via wires. The signal may subsequently be amplified electronically to increase the volume of guitar 100, and/or may be modified electronically to change the sounds produced by guitar 100. Further, in some guitars 100, plate 132 may be present, either as a decorative item or as a cover for an attachment rod (also known as a truss rod) that couples neck 104 to body 102.

### Acoustic Coupling

As described with respect to FIG. 1, an aspect of the disclosure comprises the transfer of vibration of strings 108 to the hollow space of body 102. Because these vibrations are transferred to soundboard 124 by bridge 122, the acoustic properties of bridge 122 may play a role in the efficiency of the vibrational transfer. In addition, in another aspect of the present disclosure, other properties of bridge 122 may play a role in tonal qualities of the transfer of these vibrations.

In an aspect of the present disclosure, bridge 122 may be made of a different material than the material of soundboard 124. Further, bridge 122 may be coupled to soundboard 124 in different ways, such that the transmission of vibrations between bridge 122 and soundboard 124 is more efficiently performed.

Further, in another aspect of the present disclosure, bridge 122 may provide additional transmission qualities, such as additional vibration time (which may be referred to as “sustain”), additional vibrational amplitude (which may be referred to as “volume”), or other additional vibrational attributes (e.g., timber, tone, etc.), each of which may be accentuated and/or enhanced through design and selection of bridge 122 shape and/or materials.

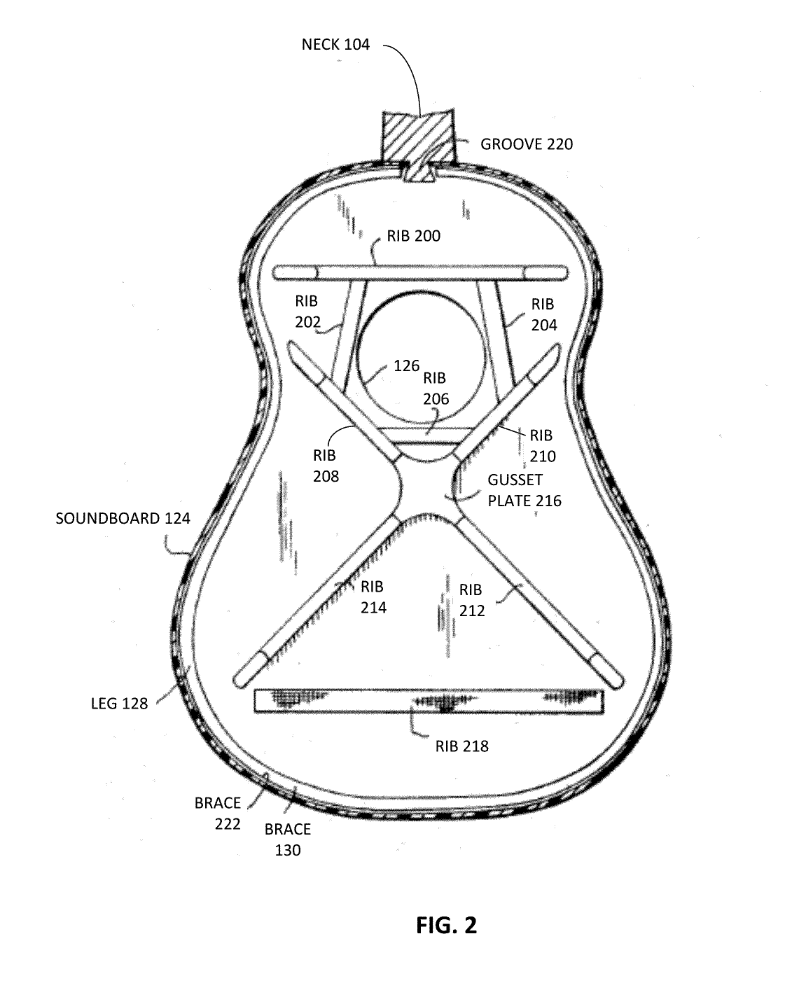

FIG. 2 illustrates one embodiment of an internal view of a soundboard in an aspect of the present disclosure.

On the inside of soundboard 124, structural elements may be used to provide mechanical support to soundboard 124 after attaching soundboard 124 to body 102. For example, near sound hole 126, ribs 200, 202, 204, 206 may be attached to soundboard 124 to mechanically strengthen soundboard 124. Further, soundboard 124 may have ribs 208, 210, 212, 214, and/or gusset plate 216, to provide cross-strengthening materials. Ribs 208, 210, 212, 214 and gusset plate 216 may be in an “X” pattern as shown in FIG. 2, or may be in other patterns without departing from the scope of the present disclosure. Other strengthening material may be placed at other locations on soundboard 124, such as rib 218. Ribs 200-214 and 218, and gusset plate 216, may be made from various materials, e.g., wood, metal, fabric, etc., and different materials may be used for one rib (e.g., rib 200) than for another rib (e.g., rib 214) as well as having a different material for gusset plate 216, without departing from the scope of the present disclosure. Also shown in FIG. 2 is groove 220 and brace 222. Groove 220 may be used to attach neck 104 to body 102, and brace 222 may be used as an additional bracing material when attaching soundboard 124 to body 102.

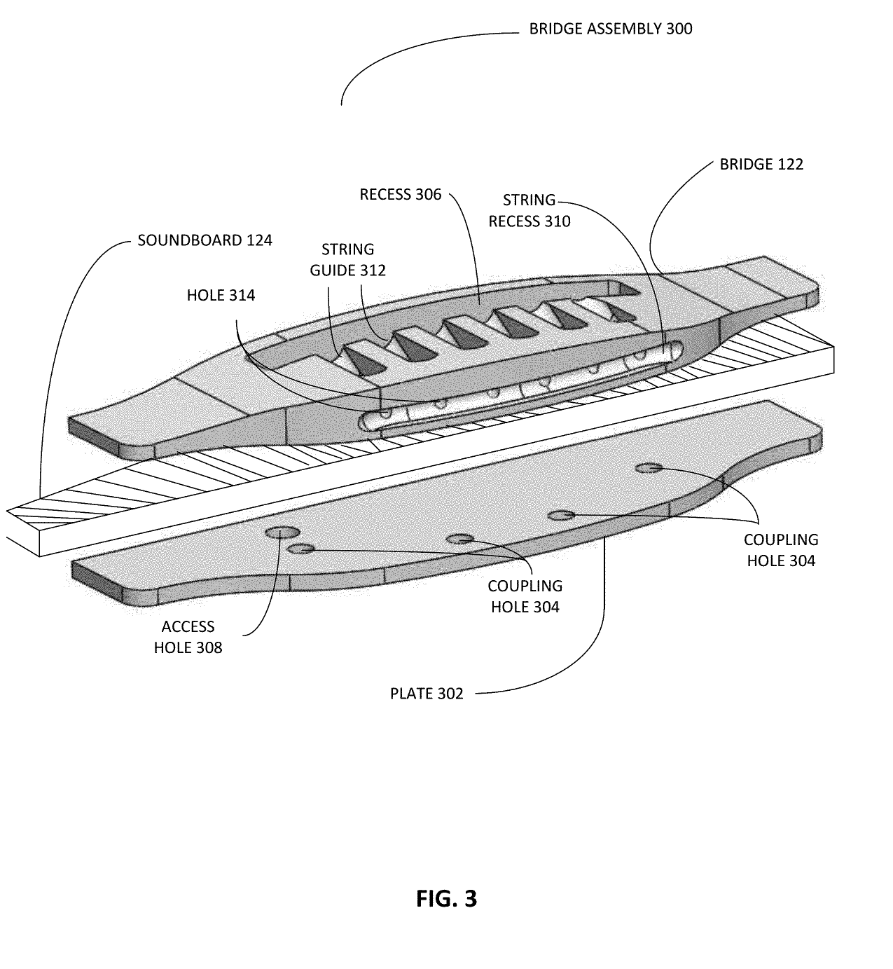

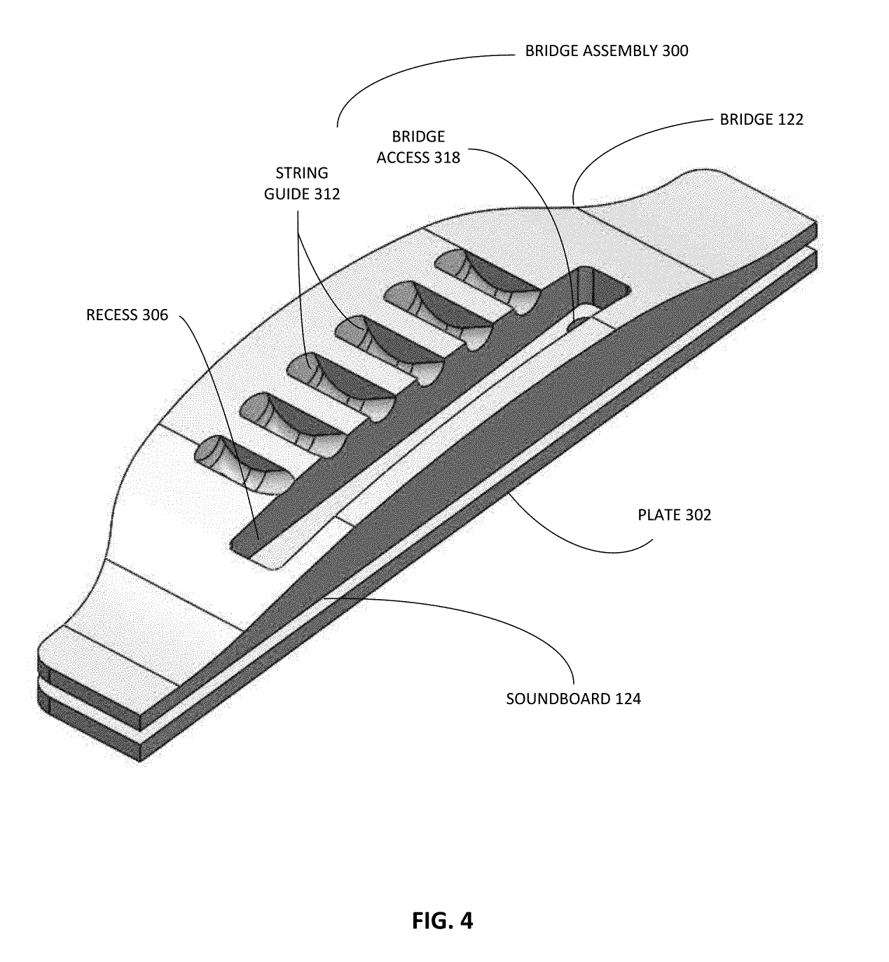

FIGS. 3 and 4 illustrate perspective cutaway views of one embodiment of a guitar bridge assembly in accordance with an aspect of the present disclosure.

Bridge assembly 300, in an aspect of the present disclosure, comprises bridge 122 and plate 302. Bridge assembly 300, in such an aspect, is attached to soundboard 124 by coupling holes 304. Coupling holes 304 allow for screws and/or other attachment devices or connectors to sandwich soundboard 124 between bridge 122 and plate 302. These attachment devices or connectors can, for example, pass through soundboard 124.

Bridge assembly 300, vis-à-vis bridge 122 in an aspect of the present disclosure, may comprise recess 306. Recess 306 may provide a positioning guide for saddle 120. Access hole 308 in plate 302 allows for wiring and/or other access to recess 306 from inside of guitar 100, i.e., on a surface of soundboard 124 that is inside of the body 102 of guitar 100. Access hole 308 can open up into recess 306, such as opening into a bottom of recess 306.

Bridge assembly 300 may also comprise string recess 310 and string guides 312 adjacent and/or connected to recess 306. String recess 310 provides a contoured and/or semi-contoured resting point for the “ball end” of strings 108. String guides 312 and holes 314 provide access to feed strings 108 through bridge 122, to be strung under tension across body 102 and along neck 104 to head 106 and tuning knobs 124. String recess 310 may face towards lower bout 110 of body 102. In other aspects of the present disclosure, string recess 310 may be on plate 302, or in another plate or location on guitar 100, as strings 108 may be “through body” strung rather than strung on the outer (“top”) surface of soundboard 124. Further, hole(s) 314 may have threaded inserts or be threaded such that fine tuning devices (not shown) may be coupled to bridge 122 at holes 314. Other tuning mechanisms, e.g., a drop tuner on one or more strings (e.g., a “drop-D” tuner for the low E string on a standard tuned guitar), half-step tuners, a whammy tremolo, or other tuning mechanisms may be coupled to or part of bridge assembly 300 without departing from the scope of the present disclosure.

As shown in FIG. 4, when plate 302 and bridge 122 are brought closer together, bridge 122 is brought into more intimate contact with soundboard 124 and/or is tightened to or against soundboard 124. Further, bridge access 318 is shown in recess 306, which allows access to saddle 110 through bridge 122.

A guitar bridge 122 may be, in related guitars, glued to soundboard 124. Further, guitar bridges 122 in related guitars are often made from wood. However, a bridge 122 made from wood, which may have an acoustic impedance of between 1.5 and 3 Mega Rayleigh (MRayl), may not accurately or completely transmit the vibrations of strings 108 to soundboard 124, at least in part because the glue used to connect bridge 122 to soundboard 124 may have a different acoustic impedance of, perhaps, 4 to 7 MRayl. Other acoustic properties of bridge 122, such as longitudinal velocity, shear velocity, density, and/or other properties, may also affect the transmission of vibrations between bridge 122 and soundboard 124. As such, some of the vibrations may be lost, absorbed, or scattered by the coupling of bridge 122 to soundboard 124.

The characteristic (acoustic) impedance of a material is given by:

Z₀=p₀c₀

where
Z₀ is the characteristic impedance,
p₀ is the density of the material, and
c₀ is the speed of sound in the medium.

By selecting material for the bridge assembly 300 (vis-à-vis bridge 122), and controlling the coupling between bridge assembly 300 and soundboard 124, an aspect of the present disclosure provides for different tonal enhancements and/or tonal transmissions between bridge 122 and soundboard 124.

In an aspect of the present disclosure, bridge assembly 300 may be made of a different material than wood, e.g., aluminum, titanium, alloys of various metals, composite materials, carbon fiber, combinations of materials, etc., which allow for different types and/or modes of transmission between bridge assembly 300 and soundboard 124. Further, because such materials can be threaded and coupled to soundboard 124 via plate 302, the coupling between bridge assembly 300 and soundboard 124 can be more precisely controlled through aspects of the present disclosure. Plate 302 can be made of the same material as bridge 122, or can be made of a different material including but not limited to those listed above. Soundboard 124 may also be made of a variety of materials, such as wood, composite materials, carbon fiber, combinations of materials, etc.

For example, and not by way of limitation, in an aspect of the present disclosure, the percussive sustain of a tonic note has been found to be longer in a bridge assembly 300 made from metal and coupled to soundboard with plate 302. This is thought to occur because of the material properties of the metal bridge assembly 300, as well as, possibly, the better coupling of bridge assembly 300 to soundboard 124 to transmit vibrations of strings 108.

Some stringed instruments, such as mandolins, 12-string guitars, and mountain dulcimers, use additional strings (sometimes referred to as “drone” strings) 108 to enhance the tonic (base) note of a chord. However, in an aspect of the present disclosure, guitar 100 may produce enhanced tonic notes because of the improved coupling of bridge assembly 300 to soundboard 124 and/or the improved matching of material properties between bridge assembly 300 and soundboard 124. Further, it has been found that the amplitude of vibrations transmitted to the saddle 110 may be increased, as bridge assembly 300 may have increased interaction with saddle 110.

Depending on the bracing used on the interior of guitar 100 employing a bridge assembly 300 in accordance with the present disclosure, plate 302 may take different shapes. For example, as shown in FIG. 2, guitar 100 may have an “X” bracing structure on the inner surface of soundboard 124. As such, plate 302 may need to fit in between ribs, e.g., ribs 212 and 214, to allow for coupling between bridge assembly 300 and soundboard 124. Further, coupling holes 304 may be placed in different locations than those shown in FIG. 3, and there may be a greater or fewer number of coupling holes than that shown in FIG. 3, without departing from the scope of the present disclosure.

Further, in an aspect of the present disclosure, the material and coupling characteristics of bridge assembly 300 may be controlled by shaping bridge assembly 300, removing and/or adding material to bridge assembly 300 in various locations, and controlling the pressure with which bridge assembly 300 is coupled to soundboard 124. Such control of the coupling/transfer of vibrations from bridge assembly 300 to soundboard 124 may balance the sound produced by guitar 100, and/or may enhance certain frequencies or tones being produced by guitar 100. For example, and not by way of limitation, bridge assembly 300 may be hollowed out such that a different amount of bridge assembly 300 is coupled to soundboard 124, which may create one or more hollows (and/or tone chambers) for resonance between bridge assembly 300 and soundboard 124 and/or creating different amounts and/or modes of resonance in soundboard 124 that may enhance specific notes or tonics in various chords. For example, one or more holes and/or hollow areas can be made in a bottom surface of bridge 122, and/or the bottom surface of bridge 122 can be textured, either of which alone or in combination would change the contact area and characteristics. Bridge assembly 300 may have user and/or manufacturer installed plugs of material, such as threaded rods, screws, or other devices, which may be made from the same material as bridge assembly 300 and/or different materials, such that the bridge assembly 300 may be “tuned” with respect to guitar 100. Such “tuning plugs” may allow a manufacturer to mate a bridge to a guitar 100 body 102, or may allow users, if the plugs may be installed on bridge assembly 300 in such a fashion that a user may access such locations, to tune bridge assembly 300 to the type of music that particular user is playing.

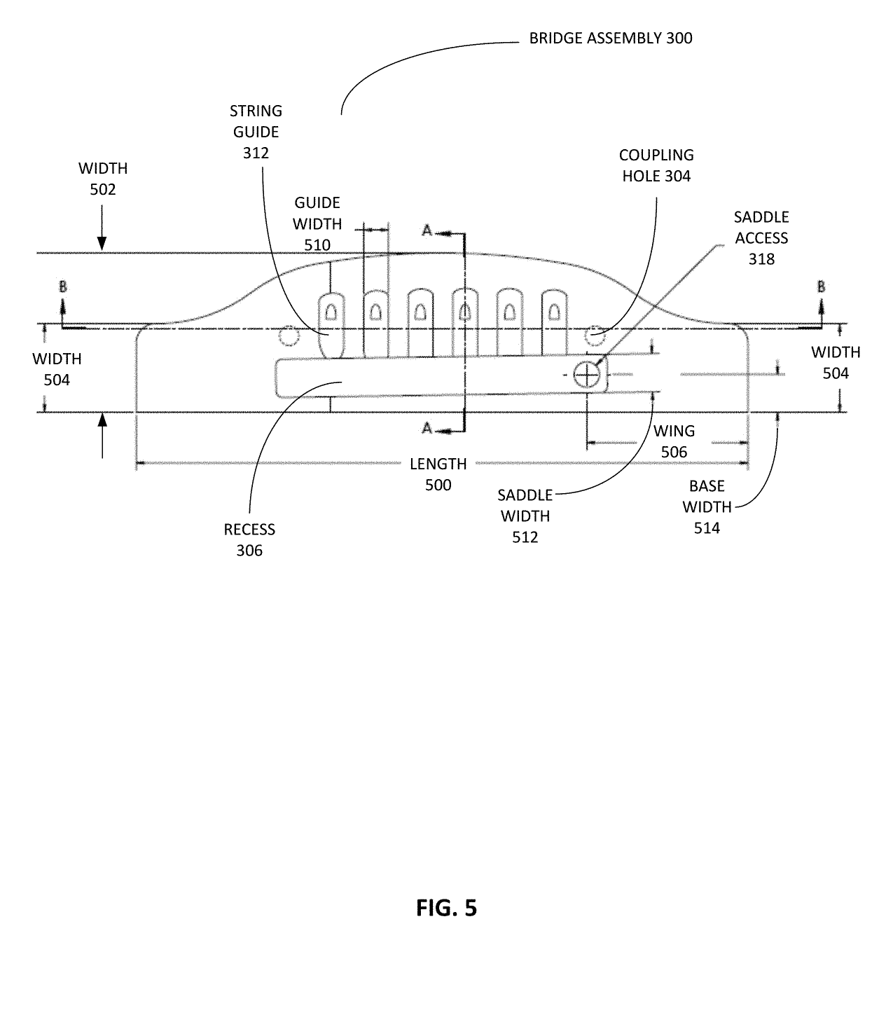

FIG. 5 illustrates a top view of a guitar bridge in accordance with an aspect of the present disclosure.

As shown in FIG. 5, bridge assembly 300 has a length 500 and a width 502. The length 500 may have a width 504 that includes the “wings” 506 of bridge assembly 300, which width 504 may also include at least a portion of string guides 312. Width 508 of recess 306 and saddle access 318 are also shown.

Guide width 510, recess width 512, and base width 514 are also shown. Each of the lengths and widths 500-514, as well as the overall shape of bridge assembly 300, may be varied within the scope of the present disclosure to selectively control the coupling between bridge assembly 300 and soundboard 124, as well as to selectively control the resonance and/or tonal qualities transferred from bridge assembly 300 to soundboard 124.

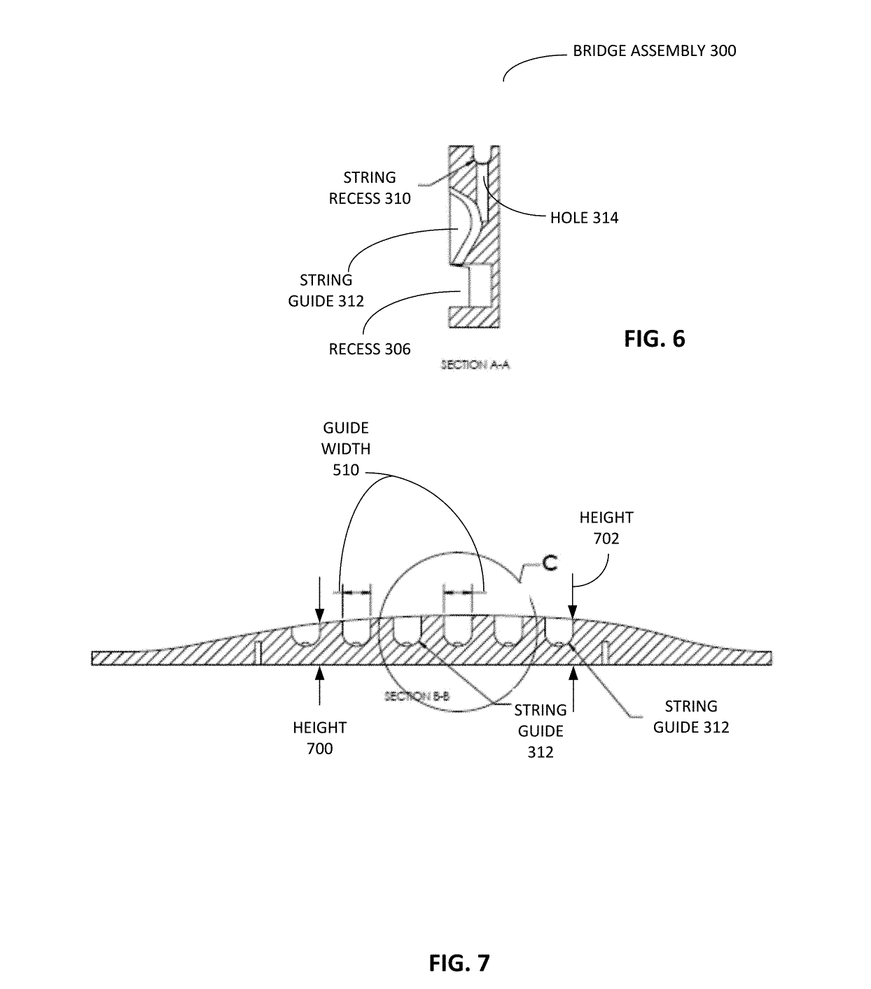

FIGS. 6 and 7 illustrate cross-sectional views of an embodiment of a guitar bridge in an aspect of the present disclosure.

FIG. 6 illustrates a cross-sectional view along line A-A in FIG. 5. As shown in FIG. 6, hole 314 couples to string guide 312 and to string recess 310, and/or connects string guide 312 to string recess 310 (it is understood that similarly situated holes can also connect string recess 310 to different string guides). Further, recess 306 is shown as optionally having a depth that may be different than the depth of string guide 312. Again, these depths and dimensions may be altered without departing from the scope of the present disclosure.

FIG. 7 illustrates a cross-sectional view along line B-B in FIG. 5. As shown in FIG. 7, the height 700 at one string may differ than the height 702 at another string along bridge assembly 300. Differing heights 700, 702 may contribute to the transfer of vibrations from strings 108, and/or each string 108 vibrates at a different frequency.

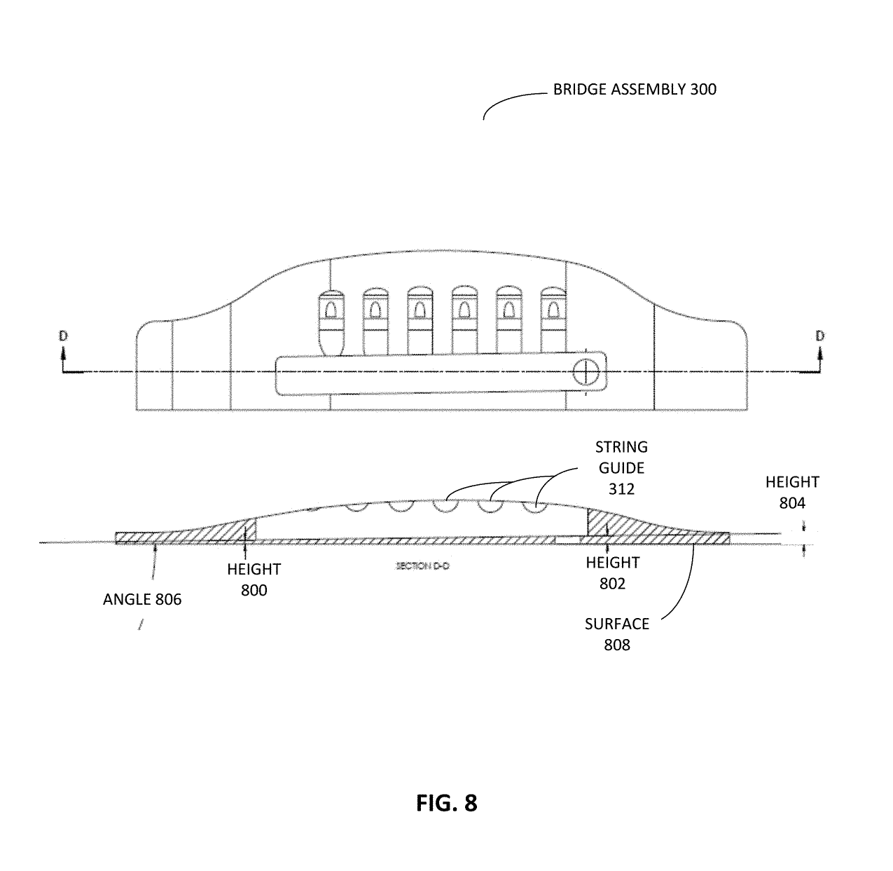

FIG. 8 illustrates a top view and cross-sectional view of one embodiment of a guitar bridge in accordance with an aspect of the present disclosure.

FIG. 8 illustrates a cross-sectional view along line D-D. As shown in FIG. 8, the string guides 312 may be at various depths within bridge assembly 300, and the height 800 of the recess 206 at one string 108 may differ than the height 802 at another string 108 along bridge assembly 300, and this may be still different than the height 804 at the edge of bridge assembly 300. Further, the angle of the base of recess 306 may be angled at one or more angles 806 with respect to the surface 808 of bridge assembly 300 that contacts and/or couples to soundboard 124. In some embodiments of the present disclosure such as that shown in FIG. 8, a bottom surface of the bridge can be flat while a top surface can be curved. A flat bottom surface such as that shown can couple well with a flat soundboard. Additionally, as previously described, recesses and/or tone chambers into the flat bottom surface may also be included.

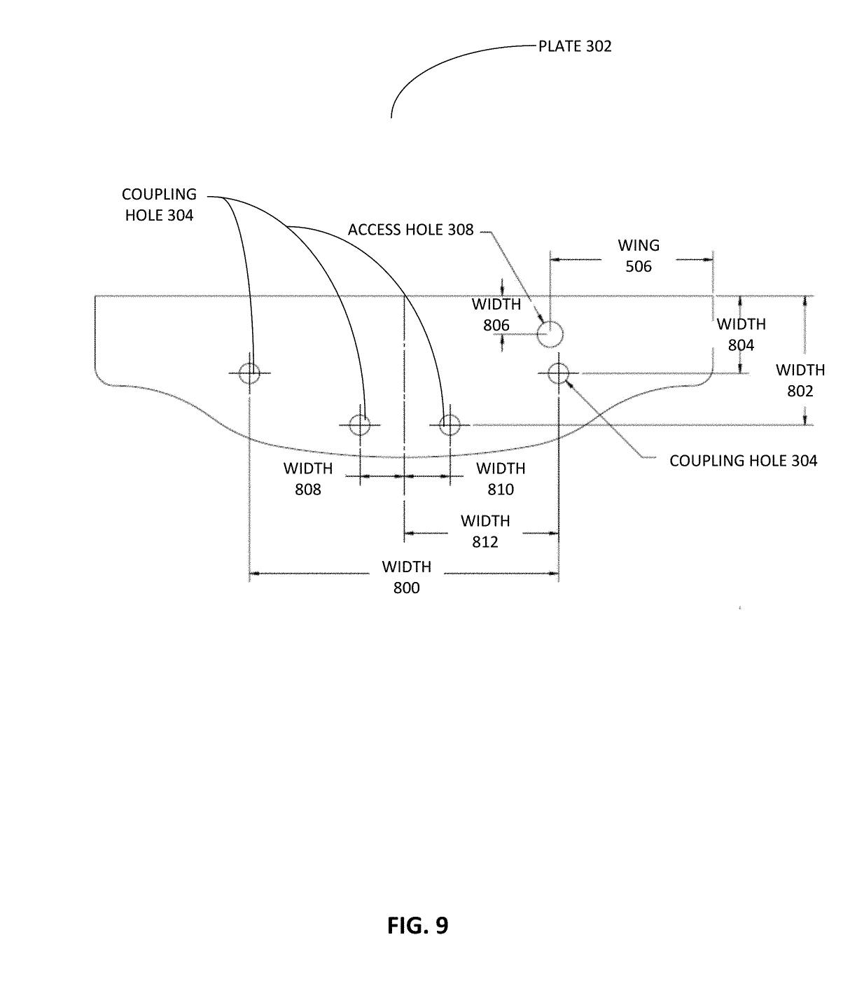

FIG. 9 illustrates a plate in accordance with an aspect of the present disclosure.

FIG. 9 illustrates widths 800-812, and wing 506, which indicate the locations of the coupling holes 304 and the access hole 308. As with the selective locations of the coupling holes 304, widths 800-812 may be varied to accommodate various locations of coupling holes 304 and/or access hole(s) 308 without departing from the scope of the present disclosure.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a device. Of course, if the device is inverted, above becomes below, and vice versa. Additionally, if oriented sideways, above and below may refer to sides of a device. Moreover, the scope of the present application is not intended to be limited to the particular configurations of the process, machine, manufacture, composition of matter, means, methods and steps described in the specification. As one of ordinary skill will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The description of the disclosure is provided to enable any person of reasonable skill to make or use the disclosure. Various modifications to the disclosure will be readily apparent to those of reasonable skilled, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein. Accordingly, the disclosure is not to be limited by the examples presented herein, but is envisioned as encompassing the scope described in the appended claims and the full range of equivalents of the appended claims.

What is claimed is:

1. A stringed instrument, comprising:
a soundboard comprising a first side and a second side;
a bridge on a portion of said first side;
a plate on a portion of said second side at least partially overlapping with said portion of said first side such that said soundboard is sandwiched between said bridge and said plate.

2. The stringed instrument of claim 1, wherein said bridge is made of a different material than said soundboard.

3. The stringed instrument of claim 2, wherein said bridge and said plate are made of the same material.

4. The stringed instrument of claim 2, wherein said bridge is made of metal.

5. The stringed instrument of claim 4, wherein said plate is made of metal.

6. The stringed instrument of claim 1, wherein said bridge is directly on said soundboard with no adhesive therebetween.

7. The stringed instrument of claim 6, said bridge comprises a flat bottom surface, said flat bottom surface directly on said soundboard.

8. The stringed instrument of claim 1, wherein said bridge is connected to said plate through said soundboard.

9. The stringed instrument of claim 8, wherein said plate is shaped to define one or more coupling holes, and wherein said bridge and said plate are connected through said soundboard by one or more connectors that pass through one of said coupling holes.

10. The stringed instrument of claim 1, wherein said bridge and said plate are connected through said soundboard by one or more connectors; and
wherein said one or more connectors can be actuated so as to tighten said bridge to said soundboard.

11. The stringed instrument of claim 1, further comprising a plurality of strings connected to said bridge.

12. A guitar bridge, comprising:
a top surface; and
a bottom surface;
wherein said top surface is shaped to define a recess and a plurality of string guides adjacent said recess.

13. The guitar bridge assembly of claim 12, wherein said bottom surface is flat and said top surface is curved.

14. The guitar bridge of claim 12, shaped to define a bridge access hole opening into a bottom of said recess.

15. The guitar bridge of claim 12, wherein a bottom of a first one of said string guides is at a first height, and wherein a bottom of a second one of said string guides is at a second height different than said first height.

16. The guitar bridge of claim 12, wherein a bottom surface of said recess is angled relative to said bottom surface of said guitar bridge.

17. The guitar bridge of claim 12, wherein said guitar bridge further comprises a side surface shaped to define a string recess, and wherein said guitar bridge is shaped to define a plurality of string holes, each of said string holes connecting said string recess to one of said string guides.

18. The guitar bridge of claim 12, wherein said guitar bridge is shaped to define one or more hollows through said bottom surface.

19. A guitar bridge assembly, comprising:
a bridge;
a plate shaped to define one or more coupling holes
one or more connectors configured to connect said plate to said bridge through a soundboard, at least one of said one or more connectors passing through one of said one or more coupling holes and attaching to said bridge.

20. The guitar bridge assembly of claim 19, comprising a plurality of connectors, wherein said plate is shaped to define a plurality of coupling holes, and wherein each of said plurality of connectors passes through one of said plurality of coupling holes and attaches to said bridge.
